(19) United States
(12) Patent Application Publication
(10) Pub. No.: US 2016/0271690 A1
(43) Pub. Date: Sep. 22, 2016

(54) CASTING AND MOLDING EQUIPMENT AND METHOD OF MANUFACTURING CASTING OF AMORPHOUS ALLOY

(71) Applicant: DONGGUAN EONTEC CO., LTD., Dongguan (CN)

(72) Inventors: Huameng FU, Dongguan (CN); Haifeng ZHANG, Dongguan (CN); Aimin WANG, Dongguan (CN); Zhengwang ZHU, Dongguan (CN); Hongwei ZHANG, Dongguan (CN); Hong LI, Dongguan (CN); Yangde LI, Dongguan (CN); Weirong LI, Dongguan (CN); Tiezhuang TANG, Dongguan (CN)

(21) Appl. No.: 15/167,985

(22) Filed: May 27, 2016

Related U.S. Application Data
(63) Continuation-in-part of application No. PCT/CN2014/085327, filed on Aug. 27, 2014.

(30) Foreign Application Priority Data
Nov. 30, 2013 (CN) 201310639506.2

(51) Int. Cl. B22D 21/02; B22D 17/10; B22D 17/14; F27D 11/02; B22D 17/26; B22D 17/28; B22D 27/00; F27D 11/06; B22D 17/00; B22D 17/20

(52) U.S. Cl. CPC B22D 21/02; B22D 17/002; B22D 17/10; B22D 17/145; B22D 17/203; B22D 17/263; B22D 17/28; B22D 27/003; F27D 11/06; F27D 11/02

(57) ABSTRACT

A casting and molding equipment for producing a casting of amorphous alloy, including an injection system, an alloy melting system, a material feeding system, a mold system, a vacuum system, a protective gas supply system, and a vacuum chamber. The alloy melting system is disposed in the vacuum chamber and includes a melting crucible and a heating unit. The heating unit is disposed out of the melting crucible. The injection system includes an injection tube, an injection mechanism, a plunger rod, and an injection piston disposed at one end of the plunger rod. The injection mechanism is adapted to control the injection piston to move in the injection tube. The injection tube includes a pouring gate. The plunger rod, the injection tube, and the injection piston are all disposed in the vacuum chamber. The plunger rod and the vacuum chamber are vacuum sealed via a bellows.

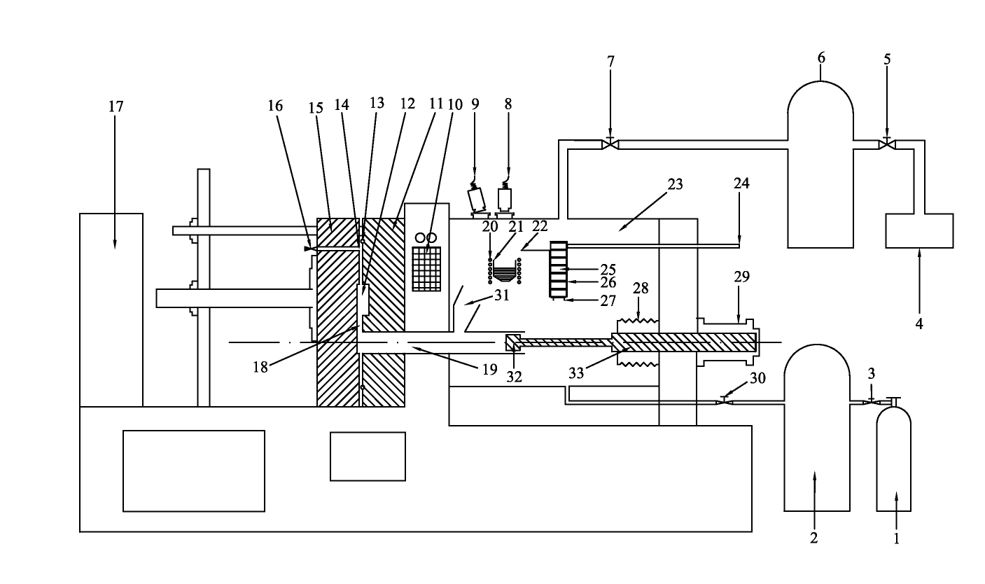

### CROSS-REFERENCE TO RELATED APPLICATIONS

This application is a continuation-in-part of International Patent Application No. PCT/CN2014/085327 with an international filing date of Aug. 27, 2014, designating the United States, now pending, and further claims priority benefits to Chinese Patent Application No. 201310639506.2 filed Nov. 30, 2013. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a casting and molding equipment and a method of manufacturing a casting of amorphous alloy using the same.

2. Description of the Related Art

Typically, the casting equipment for producing a casting of amorphous alloy includes an alloy melting unit and an injection tube which are disposed in a vacuum chamber and a protective gas-filled chamber, respectively. In practice, after each molding cycle, raw materials must be injected which releases the vacuum or destroys the protective gas environment. The inert environment needs to be reestablished in every cycle. This is inefficient.

In addition, conventional casting equipment tends to produce castings of amorphous alloy having shrinkage defects or gas porosities. This reduces the quality of the castings.

### SUMMARY OF THE INVENTION

In view of the above-described problems, it is one objective of the invention to provide a casting and molding equipment and a method of manufacturing a casting of amorphous alloy using the same. The equipment and method have high mold efficiency and the molded products have high quality.

To achieve the above objective, in accordance with one embodiment of the invention, there is provided a casting and molding equipment for producing a casting of amorphous alloy, comprising an injection system, an alloy melting system, a material feeding system, a mold system, a vacuum system, a protective gas supply system, and a vacuum chamber.

The alloy melting system is disposed in the vacuum chamber and comprises a melting crucible and a heating unit. The heating unit comprises an induction coil or resistance wire which is configured to heat the melting crucible. The heating unit is disposed out of the melting crucible.

The injection system comprises an injection tube, an injection mechanism, a plunger rod, and an injection piston disposed at one end of the plunger rod. The injection mechanism is adapted to control the injection piston to move in the injection tube via the plunger rod. The injection tube comprises a pouring gate. The plunger rod, the injection tube, and the injection piston are all disposed in the vacuum chamber. The injection mechanism is disposed out of the vacuum chamber. The plunger rod and the vacuum chamber are vacuum sealed via a bellows.

The material feeding system comprises a storage bin, a delivery chute, and a delivery rod. The storage bin is disposed in the vacuum chamber; a spring piece is disposed at a bottom of the storage bin and is capable of moving upward an alloy material in the storage bin. The delivery rod is adapted to deliver the alloy material to the melting crucible via the delivery chute.

The system comprises a fixed die, a seal ring, a moving die, a die cavity, an exhaust channel, a constant pressure one-way valve, a pouring channel, and a mold opening and closing mechanism. The mold opening and closing mechanism is configured to control the opening and closing of the fixed die and the moving die. The closing of the fixed die and the moving die generates the die cavity. The die cavity communicates with the injection tube via the pouring channel. The die cavity communicates with external environment via the exhaust channel. The constant pressure one-way valve is disposed at one end of the exhaust channel; and the fixed die and the moving die are sealed by the seal ring.

The vacuum system comprises a vacuum unit and a vacuum tank. The vacuum unit is connected to the vacuum tank via a second valve. The vacuum tank is connected to the vacuum chamber via a connecting pipe on which a third valve is disposed.

The protective gas supply system a protective gas tank and a gas storage tank connected to the protective gas tank. The gas storage tank is connected to the vacuum chamber via a gas tube on which a fourth valve is disposed; and a pipeline connecting the protective gas tank and the gas storage tank is provided with a first valve.

In a class of this embodiment, the delivery rod is adapted to deliver the alloy material to the melting crucible, and molten alloy material enters the injection tube via the pouring gate.

In a class of this embodiment, an infrared thermometer and a camera are disposed above the vacuum chamber to measure a temperature of alloy melt and monitor a molten state of the alloy material in the melting crucible, respectively.

In a class of this embodiment, the equipment further comprises a control plate configured to control the opening and closing of the fixed die and the moving die, a temperature of the heating unit, and the movement of the plunger rod.

In a class of this embodiment, the equipment is in use under vacuum or a positive pressure atmosphere.

In a class of this embodiment, the protective gas tank is filled with inert gas.

In a class of this embodiment, the constant pressure one-way valve is disposed on the fixed die and/or moving die, and a number of the constant pressure one-way valve is one or more according to design requirement.

In a class of this embodiment, the melting crucible is made of aluminum oxide or boron nitride, or is a graphite crucible having a ceramic coating.

In accordance with another embodiment of the invention, there is provided a method for casting and molding a casting of amorphous alloy using the casting and molding equipment, the method comprising:
(1) tightly coupling the fixed die and the moving die via the seal ring, disposing the constant pressure one-way valve on the exhaust channel, to yield the die cavity which is sealed;
(2) placing the storage bin filled with the alloy material in the vacuum chamber, pushing upward the alloy material by the spring piece at the bottom of the storage bin, pushing the plunger rod towards the melting crucible so that the alloy material falls into the melting crucible via the delivery chute;
(3) opening the second valve and starting the vacuum unit to vacuumize the vacuum tank; opening the third valve and vacuumizing the die cavity, the injection tube, and the storage bin; when the casting and molding equipment is required to work under vacuum, then proceed to next step; when the casting and molding equipment is required to work under a positive pressure atmosphere, opening the first valve and inflating the gas storage tank with a protective gas, and then opening the fourth valve, inflating the vacuum chamber, the die cavity, the injection tube, and the storage bin with the protective gas to reach a pressure, adjusting the pressure by the constant pressure one-way valve;
(4) starting the heating unit and fully melting the alloy material, pouring molten alloy material into the injection tube via the pouring gate through a turnover mechanism, pushing the plunger rod and the injection piston to drive the molten alloy material to enter the die cavity; opening the constant pressure one-way valve to discharge surplus gas from the exhaust channel when the die cavity is being filled in;
(5) molding the molten alloy material in the die cavity, cooling, inflating the die cavity with external gas via the gas tube to balance a gas pressure in the die cavity, opening the die cavity and collecting a mold; and
(6) repeating above steps for a next cycle.

In a class of this embodiment, the vacuumization of the vacuum tank by the vacuum unit is only performed in an initial cycle, or the opening of the first valve and the inflation of the gas storage tank with the protective gas are only performed in an initial cycle.

In a class of this embodiment, when the casting and molding equipment is working under vacuum, a vacuum degree is 10⁻² Pascal.

In a class of this embodiment, when the casting and molding equipment is working under a positive pressure atmosphere, the protective gas has a pressure of between 1 and 1.5 atmospheric pressure.

The casting and molding equipment of the invention is adapted to prepare a casting of amorphous alloy including but not limited to Zr-based amorphous alloy, Ti-based amorphous alloy, Fe-based amorphous alloy, Ni-based amorphous alloy, Al-based amorphous alloy, Mg-based amorphous alloy, Cu-based amorphous alloy, and can also be practicable to preparation of active metal components such as Ti alloy, Al alloy, and Mg alloy.

The principle of the invention is summarized as follows. The material feeding system is efficiently incorporated in the casting and molding equipment, which facilitates the material supply. The vacuum tank and the gas storage tank are introduced to the vacuum system or the protective gas supply system, so that during melting, demolding and molding, the vacuum tank can be vacuumized and the gas storage tank can be filled with protective gas in advance, thus saving the production time and improving the production efficiency of each production cycle. In addition, the casting and molding equipment has compact and simple structure, low maintenance cost, and is practicable to continuous automatic production.

The casting and molding equipment is particularly practicable to the preparation of a casting of amorphous alloy. The preparation of the casting of amorphous alloy can be performed under vacuum or in the positive pressure protective gas atmosphere, and the space requiring the vacuum protection or protective atmosphere is small. The arrangement of the exhaust channel on the mold can prevent the formation of micro shrinkage holes on the surface of the casting of amorphous alloy, thus improving the product quality. The high vacuum tank or the protective gas tank can continuously produce the vacuum environment or the protective gas source, thus ensuring the steady molding conditions, shortening the production cycle, saving the production cost, and improving the production efficiency.

Advantages of the casting and molding equipment and a method of manufacturing a casting of amorphous alloy using the same according to embodiments of the invention are summarized as follows.
1. The casting and molding equipment comprises a material feeding system, thus ensuring the persistent supply of the raw material.
2. The production cycle for molding a casting of amorphous alloy is reduced, and the production efficiency is improved.

### BRIEF DESCRIPTION OF THE DRAWINGS

The invention is described hereinbelow with reference to accompanying drawings, in which the sole FIGURE is a schematic diagram of a casting and molding equipment for producing a casting of amorphous alloy in accordance with one embodiment of the invention.

In the drawings, the following reference numbers are used: 1. Protective gas tank; 2. Gas storage tank; 3. First valve; 5. Second valve; 7. Third valve; 30. Fourth valve; 4. Vacuum unit; 6. Vacuum tank; 8. Infrared thermometer; 9. Camera; 10. Control plate; 11. Fixed die; 12. Die cavity; 13. Seal ring; 14. Exhaust channel; 15. Moving die; 16. Constant pressure one-way valve; 17. Mold opening and closing mechanism; 18. Pouring channel; 19. Injection tube; 20. Heating unit; 21. Melting crucible; 22. Delivery chute; 23. Vacuum chamber; 24. Delivery rod; 25. Alloy material; 26. Storage bin; 27. Spring piece; 28. Bellows; 29. Injection mechanism; 31. Pouring gate; 32. Injection piston; 33. Plunger rod.

### DETAILED DESCRIPTION OF THE EMBODIMENTS

For further illustrating the invention, experiments detailing a casting and molding equipment and a method of manufacturing a casting of amorphous alloy using the same are described below. It should be noted that the following examples are intended to describe and not to limit the invention.

As shown in the sole FIGURE, the invention provides a casting and molding equipment for producing a casting of amorphous alloy, comprising an injection system, an alloy melting system, a material feeding system, a mold system, a vacuum system, a protective gas supply system, and a vacuum chamber.

The alloy melting system is disposed in the vacuum chamber 23 and comprises a melting crucible 21 and a heating unit 20. The melting crucible 21 is made of aluminum oxide or boron nitride, or is a graphite crucible having a ceramic coating. The heating unit 20 comprises an induction coil or resistance wire which is configured to heat the melting crucible 21. The heating unit 20 is disposed out of the melting crucible 21.

The injection system comprises an injection tube 19, an injection mechanism 29, a plunger rod 33, and an injection piston 32 disposed at one end of the plunger rod 33. The injection mechanism 29 is adapted to control the injection piston 32 to move in the injection tube 19 via the plunger rod 33. The injection tube 19 comprises a pouring gate 31. The plunger rod 33, the injection tube 19, and the injection piston 32 are all disposed in the vacuum chamber 23. The injection mechanism 29 is disposed out of the vacuum chamber 23. The plunger rod 33 and the vacuum chamber 23 are vacuum sealed via a bellows 8, which can effectively reduce the leakage probability of the dynamic seal structure.

The material feeding system comprises a storage bin 26, a delivery chute 22, and a delivery rod 24. The storage bin 26 is disposed in the vacuum chamber 23; a spring piece 27 is disposed at the bottom of the storage bin 26 and is capable of moving upward an alloy material 25 in the storage bin 26. The delivery rod 24 is adapted to deliver the alloy material 25 to the melting crucible 21 via the delivery chute 22. The molten alloy material 25 is dumped into the injection tube 19 via the pouring gate 31. A cover is disposed at the top of the storage bin 26. After the alloy material is loaded, the cover is fixed on the storage bin 26 to limit the top of the alloy material. Side walls of the storage bin 26 are provided with holes, the delivery rod 24 delivers the alloy material to the melting crucible 21 via the holes of the storage bin 26.

The mold system comprises a fixed die 11, a seal ring 13, a moving die 15, a die cavity 12, an exhaust channel 14, a constant pressure one-way valve 16, a pouring channel 18, and a mold opening and closing mechanism 17. The constant pressure one-way valve 16 is disposed on the fixed die 11 and/or moving die 15, and a number of the constant pressure one-way valve 16 is one or more according to design requirement. The mold opening and closing mechanism 17 is configured to control the opening and closing of the fixed die 11 and the moving die 15. The closing of the fixed die 11 and the moving die 15 generates the die cavity 12. The die cavity 12 communicates with the injection tube 19 via the pouring channel 18. The die cavity 12 communicates with external environment via the exhaust channel 14. The constant pressure one-way valve 16 is disposed at one end of the exhaust channel 14; and the fixed die 11 and the moving die 15 are sealed by the seal ring 13.

The vacuum system comprises a vacuum unit 4 and a vacuum tank 6. The vacuum unit 4 is connected to the vacuum tank 6 via a second valve 5. The vacuum tank 6 is connected to the vacuum chamber 23 via a pipe on which a third valve 7 is disposed.

The protective gas supply system a protective gas tank 1 and a gas storage tank 2 connected to the protective gas tank 1. The protective gas tank 1 is filled with inert gas. The gas storage tank 2 is connected to the vacuum chamber 23 via a gas tube on which a fourth valve 30 is disposed; and a pipeline connecting the protective gas tank 1 and the gas storage tank 2 is provided with a first valve 3.

An infrared thermometer 8 and a camera 9 are disposed above the vacuum chamber 23 to measure a temperature of alloy melt and monitor a molten state of the alloy material in the melting crucible 21, respectively.

The casting and molding equipment further comprises a control plate 10 configured to control the opening and closing of the fixed die 11 and the moving die 15, the temperature of the heating unit 20, and the movement of the plunger rod 33.

The equipment is practicable in use under vacuum or a positive pressure atmosphere.

A method for casting and molding a casting of amorphous alloy using the casting and molding equipment, comprises the following steps:
1) tightly coupling the fixed die 11 and the moving die 15 via the seal ring 13, disposing the constant pressure one-way valve 16 on the exhaust channel 14, to yield the die cavity 12 which is sealed;
2) placing the storage bin 26 filled with the alloy material 25 in the vacuum chamber 23, pushing upward the alloy material 25 by the spring piece 27 at the bottom of the storage bin 26, pushing the plunger rod 24 towards the melting crucible so that the alloy material 25 falls into the melting crucible 21 via the delivery chute 22;
3) opening the second valve 5 and starting the vacuum unit 4 to vacuumize the vacuum tank 6; opening the third valve 7 and vacuumizing the die cavity 12, the injection tube 19, and the storage bin 26; when the casting and molding equipment is required to work under vacuum, then proceed to next step; when the casting and molding equipment is required to work under positive pressure atmosphere, opening the first valve 3 and inflating the gas storage tank 2 with a protective gas, and then opening the fourth valve 30, inflating the vacuum chamber 23, the die cavity 12, the injection tube 19, and the storage bin 26 with the protective gas to reach a pressure, adjusting the pressure by the constant pressure one-way valve 16;
4) starting the heating unit 20 and fully melting the alloy material 25, pouring molten alloy material into the injection tube 19 via the pouring gate 31 through a turnover mechanism, pushing the plunger rod 33 and the injection piston 32 to drive the molten alloy material to enter the die cavity 12; opening the constant pressure one-way valve 16 to discharge surplus gas from the exhaust channel 14 when the die cavity 12 is being filled in;
5) molding the molten alloy material in the die cavity 12, cooling, inflating the die cavity with external gas via the gas tube to balance a gas pressure in the die cavity (when a positive pressure atmosphere is present, the charging process can be omitted), opening the die cavity and collect a mold; and
6) repeating above steps for a next cycle.

The vacuumization of the vacuum tank 6 by the vacuum unit 4 is only performed in an initial cycle, or the opening of the first valve 3 and the inflation of the gas storage tank with the protective gas are only performed in an initial cycle.

In the method, when the casting and molding equipment is working under vacuum, a vacuum degree is 10⁻² Pascal.

In the method, when the casting and molding equipment is working under positive pressure atmosphere, the protective gas has a pressure of between 1 and 1.5 atmospheric pressure.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A casting and molding equipment for producing a casting of amorphous alloy, the equipment comprising:
an alloy melting system;
an injection system;
a material feeding system;
a mold system;
a vacuum system;
a protective gas supply system; and
a vacuum chamber;
wherein
the alloy melting system is disposed in the vacuum chamber and comprises a melting crucible and a heating unit; the heating unit comprises an induction coil or resistance wire which is configured to heat the melting crucible; the heating unit is disposed out of the melting crucible;
the injection system comprises an injection tube, an injection mechanism, a plunger rod, and an injection piston disposed at one end of the plunger rod; the injection mechanism is adapted to control the injection piston to move in the injection tube via the plunger rod; the injection tube comprises a pouring gate; the plunger rod, the injection tube, and the injection piston are all disposed in the vacuum chamber; the injection mechanism is disposed out of the vacuum chamber; the plunger rod and the vacuum chamber are vacuum sealed via a bellows;
the material feeding system comprises a storage bin, a delivery chute, and a delivery rod; the storage bin is disposed in the vacuum chamber; a spring piece is disposed at a bottom of the storage bin and is capable of moving upward an alloy material in the storage bin; the delivery rod is adapted to deliver the alloy material to the melting crucible via the delivery chute;
the mold system comprises a fixed die, a seal ring, a moving die, a die cavity, an exhaust channel, a constant pressure one-way valve, a pouring channel, and a mold opening and closing mechanism; the mold opening and closing mechanism is configured to control the opening and closing of the fixed die and the moving die; the closing of the fixed die and the moving die generates the die cavity; the die cavity communicates with the injection tube via the pouring channel; the die cavity communicates with external environment via the exhaust channel; the constant pressure one-way valve is disposed at one end of the exhaust channel; and the fixed die and the moving die are sealed by the seal ring;
the vacuum system comprises a vacuum unit and a vacuum tank; the vacuum unit is connected to the vacuum tank via a second valve; the vacuum tank is connected to the vacuum chamber via a connecting pipe on which a third valve is disposed; and
the protective gas supply system a protective gas tank and a gas storage tank connected to the protective gas tank; the gas storage tank is connected to the vacuum chamber via a gas tube on which a fourth valve is disposed; and a pipeline connecting the protective gas tank and the gas storage tank is provided with a first valve.

2. The equipment of claim 1, wherein the delivery rod is adapted to deliver the alloy material to the melting crucible, and molten alloy material enters the injection tube via the pouring gate.

3. The equipment of claim 1, wherein an infrared thermometer and a camera are disposed above the vacuum chamber to measure a temperature of alloy melt and monitor a molten state of the alloy material in the melting crucible, respectively.

4. The equipment of claim 1, further comprising a control plate configured to control the opening and closing of the fixed die and the moving die, a temperature of the heating unit, and the movement of the plunger rod.

5. The equipment of claim 1, being in use under vacuum or a positive pressure atmosphere.

6. The equipment of claim 1, wherein the protective gas tank is filled with inert gas.

7. The equipment of claim 1, wherein the constant pressure one-way valve is disposed on the fixed die and/or moving die, and a number of the constant pressure one-way valve is one or more according to design requirement.

8. The equipment of claim 1, wherein the melting crucible is made of aluminum oxide or boron nitride, or is a graphite crucible having a ceramic coating.

9. A method for casting and molding a casting of amorphous alloy using the casting and molding equipment of claim 1, the method comprising:
(1) tightly coupling the fixed die and the moving die via the seal ring, disposing the constant pressure one-way valve on the exhaust channel, to yield the die cavity which is sealed;
(2) placing the storage bin filled with the alloy material in the vacuum chamber, pushing upward the alloy material by the spring piece at the bottom of the storage bin, pushing the plunger rod towards the melting crucible so that the alloy material falls into the melting crucible via the delivery chute;
(3) opening the second valve and starting the vacuum unit to vacuumize the vacuum tank; opening the third valve and vacuumizing the die cavity, the injection tube, and the storage bin; when the casting and molding equipment is required to work under vacuum, then proceed to next step; when the casting and molding equipment is required to work under a positive pressure atmosphere, opening the first valve and inflating the gas storage tank with a protective gas, and then opening the fourth valve, inflating the vacuum chamber, the die cavity, the injection tube, and the storage bin with the protective gas to reach a pressure, adjusting the pressure by the constant pressure one-way valve;
(4) starting the heating unit and fully melting the alloy material, pouring molten alloy material into the injection tube via the pouring gate through a turnover mechanism, pushing the plunger rod and the injection piston to drive the molten alloy material to enter the die cavity; opening the constant pressure one-way valve to discharge surplus gas from the exhaust channel when the die cavity is being filled in;
(5) molding the molten alloy material in the die cavity, cooling, inflating the die cavity with external gas via the gas tube to balance a gas pressure in the die cavity, opening the die cavity and collecting a mold; and
(6) repeating above steps for a next cycle.

10. The method of claim 9, wherein the vacuumization of the vacuum tank by the vacuum unit is only performed in an initial cycle, or the opening of the first valve and the inflation of the gas storage tank with the protective gas are only performed in an initial cycle.

11. The method of claim 9, wherein when the casting and molding equipment is working under vacuum, a vacuum degree is 10⁻² Pascal.

12. The method of claim 9, wherein when the casting and molding equipment is working under a positive pressure atmosphere, the protective gas has a pressure of between 1 and 1.5 atmospheric pressure.
